(19) United States
(12) Patent Application Publication
(10) Pub. No.: US 2008/0262873 A1
(43) Pub. Date: Oct. 23, 2008

(54) PATIENT MANAGEMENT SYSTEM AND METHOD

(75) Inventors: C. Gresham Bayne, San Diego, CA (US); Gresham B. Bayne, San Diego, CA (US); Michael Morgan, San Diego, CA (US); James H. Collins, San Diego, CA (US)

Correspondence Address: DUCKOR SPRADLING METZGER & WYNNE;A LAW CORPORATION, 3043 4th Ave., SAN DIEGO, CA, 92103, US

(73) Assignee: Janus Health, Inc.

(21) Appl. No.: 11/743,131

(22) Filed: May 1, 2007

Related U.S. Application Data
(60) Provisional application No. 60/912,668, filed on Apr. 18, 2007.

(51) Int. Cl. G06Q 50/00; G06F 19/00

(52) U.S. Cl. 705/3; 705/2; 707/10

(57) ABSTRACT

A patient management system and method are provided. The patient management system may include portable computers for the clinicians making house calls, a centralized database for storing patient medical records, and an office system for communicating with the portable computer to provide the clinician with patient medical information by accessing the database and receive patient visit medical information from the physician. The operating system may also update the database with the patient visit information House calls may be made to single family/person residences, congregate care facilities or communities, and others.

### FIELD OF THE INVENTION

The present invention relates in general to a patient management system and method. It more particularly relates to a patient management system for mobile clinicians making house calls.

### RELATED APPLICATIONS

This application claims priority to U.S. provisional patent application, entitled PATIENT MANAGEMENT SYSTEM AND METHOD, Application No. 60/912,668, filed Apr. 18, 2007, and is herein incorporated by reference. This application is related to U.S. patent application, entitled PATIENT MANAGEMENT SYSTEM AND METHOD, Application No. tbd, filed May 1, 2007, and is herein incorporated by reference.

### BACKGROUND ART

This section describes the background of the disclosed embodiment of the present invention. There is no intention, either express or implied, that the background art discussed in this section legally constitutes prior art.

Currently, a mobile care entity may provide medical services for patients in the home or at other premises by means of a network of mobile clinicians each having a preprogrammed portable computer. The mobile clinicians may conduct in-home patient visits utilizing on-site diagnostic and treatment equipment, where the service is enhanced by the use of portable computing and communications equipment. Such a system and method is described in U.S. patent application Ser. No. 10/934,802, which is herein incorporated by reference.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a block diagram for a patient management system according to an embodiment of the present invention;

FIG. 2 is a flow diagram for a patient visit for the patient management system of FIG. 1;

FIG. 3 is a flow diagram for a physician placing an order for the patient management system of FIG. 1;

FIG. 4 is another flow diagram for a physician placing an order for the patient management system of FIG. 1;

FIG. 5 is a flow diagram for the physician dictating notes to a transcription service according to the flow diagram of FIG. 2.

FIG. 6 is a form for documenting the patient visit for the patient management system of FIG. 2;

FIG. 7 is an order form used by the physician for the patient management system of FIG. 3; and

FIG. 8 is an order form sent to a third party agent for the patient management system of FIG. 3.

### DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

According to an embodiment of the invention, a patient management system and method are provided employing a centralized office system for coordinating a plurality of mobile medical groups. The office system includes a group of software modules shared by the medical groups.

According to certain embodiments of the invention, there is provided a patient management system for clinicians such as physicians or others, making house calls. The patient management system may include portable computers for the clinicians making house calls, a centralized database for storing patient medical records, and an office system for communicating with the portable computer to provide the clinician with patient medical information by accessing the database and receive patient visit medical information from the physician. The operating system may also update the database with the patient visit information. House calls may be made to single family/person residences, congregate care facilities or communities, and others.

According to another embodiment of the invention, there is provided a patient management system for clinicians making housing calls. The patient management system may include a portable computer for each clinician making house calls, centralized electronic storage for patient medical records, and an office system for communicating with the portable computers and the centralized storage, and for providing online access to the centralized storage.

According to yet another embodiment of the invention, there is provided a method of patient management for clinicians making house calls. The method may include providing portable computers for the clinicians to use when making house calls, receiving appointment data regarding an appointment for a patient with a selected clinician at a predetermined time, transmitting appointment information regarding the appointment to the selected clinician via his provided portable computer, transmitting patient data to the selected clinician's portable computer, pre-filling a form with the patient data at the selected clinician's portable computer, receiving from the selected clinician's portable computer patient visit data electronically added to the form during the appointment, acknowledging the receipt of the patient visit data, verifying the patient visit data, and updating the patient's medical records.

According to still another embodiment of the invention, there is provided a patient management system for a plurality of medical groups having clinicians making house calls. The patient management system may include at least one portable computer for each of the medical groups, centralized electronic storage for storing patient medical records of the medical groups, and an office system for communicating with the medical groups and the centralized storage, and providing access to the centralized storage.

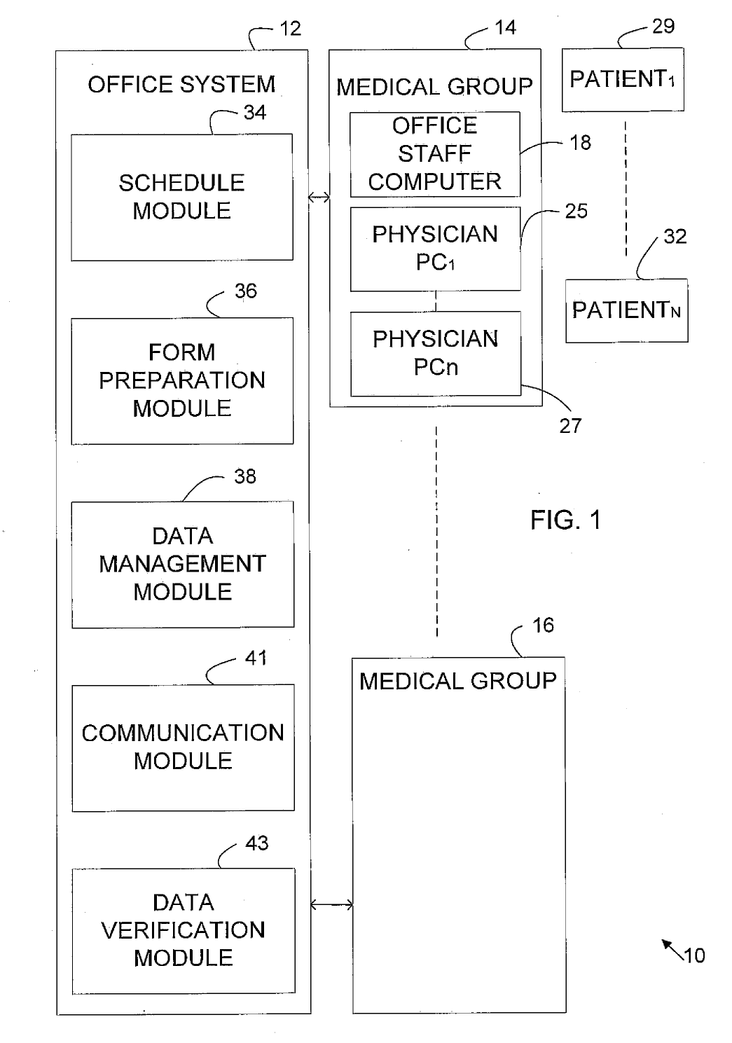

Referring now to the FIG. 1, there is shown an embodiment of a patient management system 10 for clinicians such as physicians, physician assistants, nurse practitioners and others, to facilitate in making house calls. For sake of clarity, a physician will be referred to in the following examples. The patient management system may include a centralized office system 12 providing services to a plurality of mobile medical groups 14, 16. Each medical group, such as the medical group 14, may include an office staff computer 18 for access by members of the office staff and a plurality of physician portable computers 25, 27 (Physician PC₁—Physician PCₙ). The physicians may utilize their portable computers while visiting patients such as patients 29, 32 (Patient₁—Patient_{N}) in the patient's home or other facility, to communicate with an office system computer by a wireless or other connection. The office system 12 may include a schedule module 34 for scheduling the physicians' visits to the patients, a form preparation module 36 for providing forms for use by the physicians, a data management module 38 for storing, retrieving, and updating patient records, a communication module 41 for communicating with the office staff and the physicians of the medical groups, and a data verification module 43 for checking and verifying the data from the physicians and for verifying the authenticity of data.

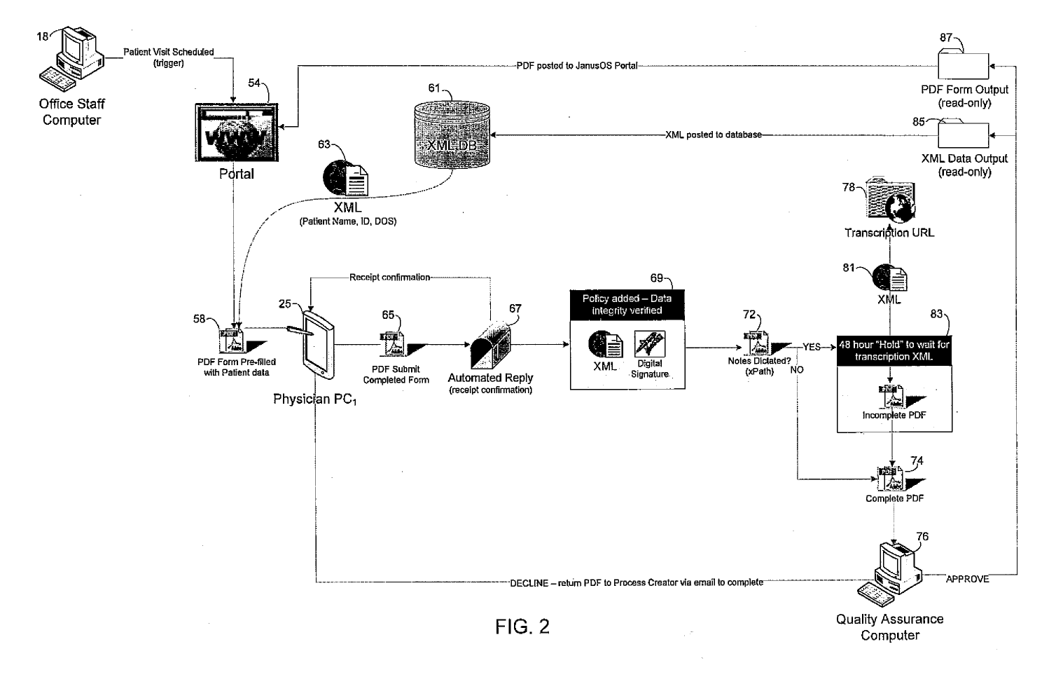

Referring now to FIG. 2, there is shown a flow diagram representing a typical sequence for a patient visit using the patient management system 10 of FIG. 1. The sequence may be initiated by a patient contacting a member of an office staff of a medical group requesting a home visit by a physician. The office staff may access the office system 12 using an office staff computer 18 through an office system portal 54 to schedule the visit by selecting the physician and the time/date, and providing the reason for the visit.

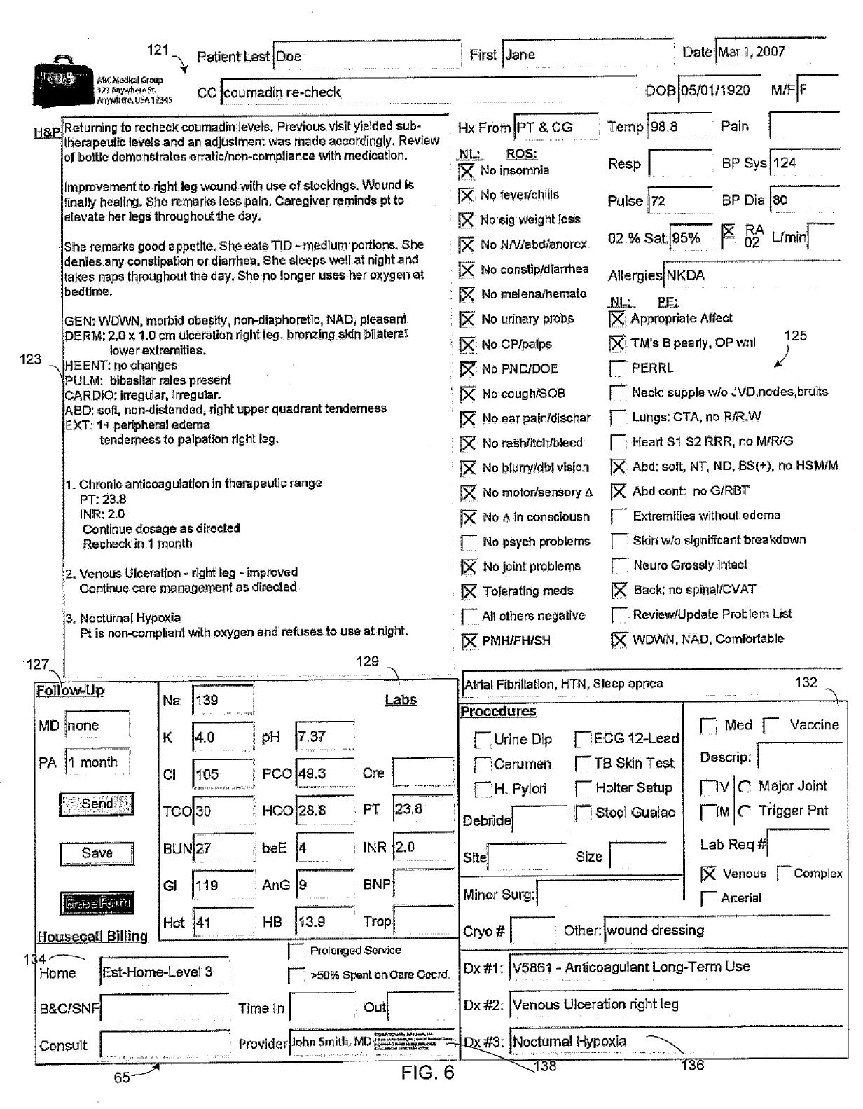

The office system 12 may then send a secure email or other communication to the selected physician via his/her portable computer 25. The email may include a patient form 58 (FIGS. 2 and 6) pre-filled with patient XML data 63, a map (not shown) and/or directions to the patient's home, and other notes (not shown) or information deemed necessary. If medical records for the patient have been previously entered into the system, the email may also include a link to the patient's medical record in an XML database 61 to enable the physician to access patient information 63 in XML format.

Once the physician has visited the patient such as the patient 29 (FIG. 1), and completed a PDF submit 65, which is, in this example, the patient form 58 (FIGS. 2 and 6), by inputting data including his or her digital signature using his/her portable computer 25, the physician may submit the data from the completed patient form 58 to the office system 12 using the portable computer 25. The office system may provide an automatic reply 67 to the physician via portable computer 25 confirming receipt of the data from the completed patient form 65.

Upon receipt of the data from the completed patient form 65 from the physician via the portable computer 25, the office system 12 at reference number 69 may check the validity of the digital signature using a certificate authority and verify the integrity of the data to insure the data was not modified after the application of the digital signature.

Once the integrity of the data is verified, the office system 12 as indicated at 72, may decide whether the physician had dictated notes to be included with data from the completed patient form 65. If the physician has dictated notes and some physicians may prefer to dictate notes at the patient's home instead of entering them into the patient form using their portable computer 25, then the data may be held at 83 to wait for the transcription of the notes.

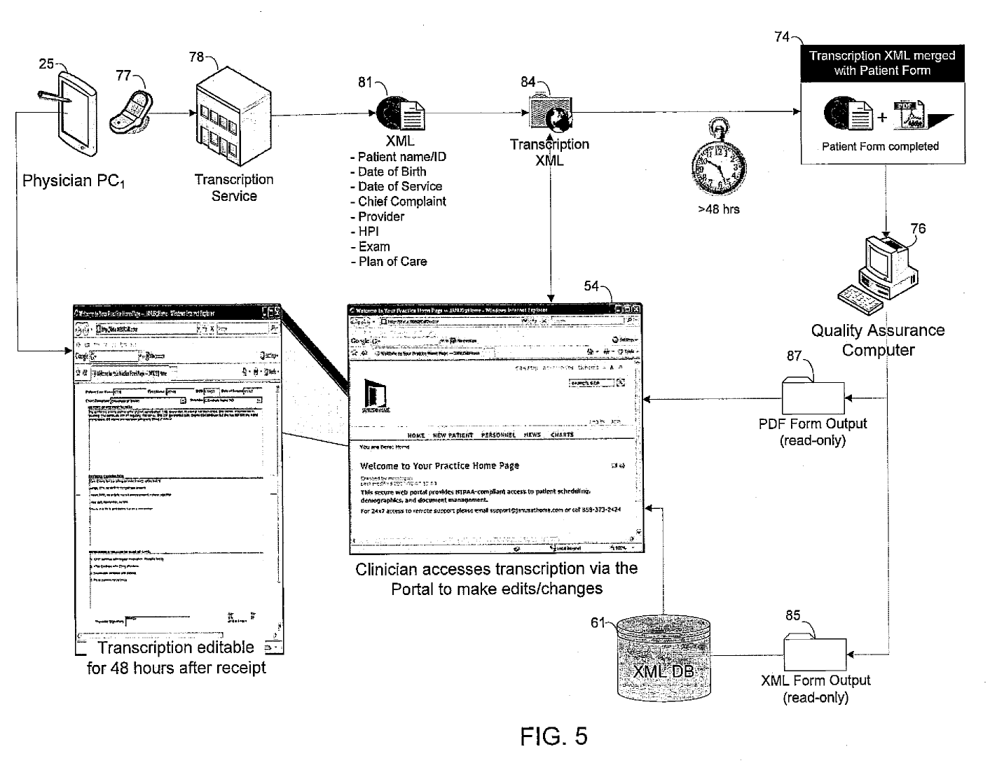

To dictate notes, the physician may call a transcription service 78 using his/her telephone 77 or other means of communication and dictate the notes in a voicemail as indicated in FIG. 5. The transcription service 78 may transcribe the notes and provide the transcribed notes 81 in XML format (FIG. 5) or other suitable format to the office system's transcription XML repository 84. The transcribed notes 81 may include a plurality of information regarding the patient including name, date of birth, date of service, etc. The physician may access the transcription via the portal 54 using the portable computer 25 to make edits and/or changes. The office system may then merge the transcription 81 (FIGS. 2 and 5) with the held data at 83 into the completed patient form 74.

If the physician did not dictate any notes to be included on the patient form or the dictated notes have been merged onto the patient form, then the completed patient form 74 may be provided to a quality assurance member via a quality assurance computer 76, who may determine if the patient form 74 meets a variety of healthcare compliance standards. If the form is declined, the quality assurance member may email the incomplete form to the physician via the portable computer 25 for completion. If the patient form is approved by the quality assurance member 76, a completed patient form 87 in read-only format may be posted on the office system portal 54 for viewing, and the completed patient form data 85 in read-only format may be provided to the database 61 for updating the patient's medical record.

In most cases in the above description of FIG. 2, when information is being sent from the office system to the physician's portable computer, the information may be transferred in an extensible Markup Language (XML) or other suitable document format to substantially reduce the size of the data being sent. Both the office system and the physician's portable computer may then contain the appropriate software to use this XML document to populate another user interface such as a user friendly document, e.g., a Portable Document Format (PDF) document, for permitting the physician or other person to read the information.

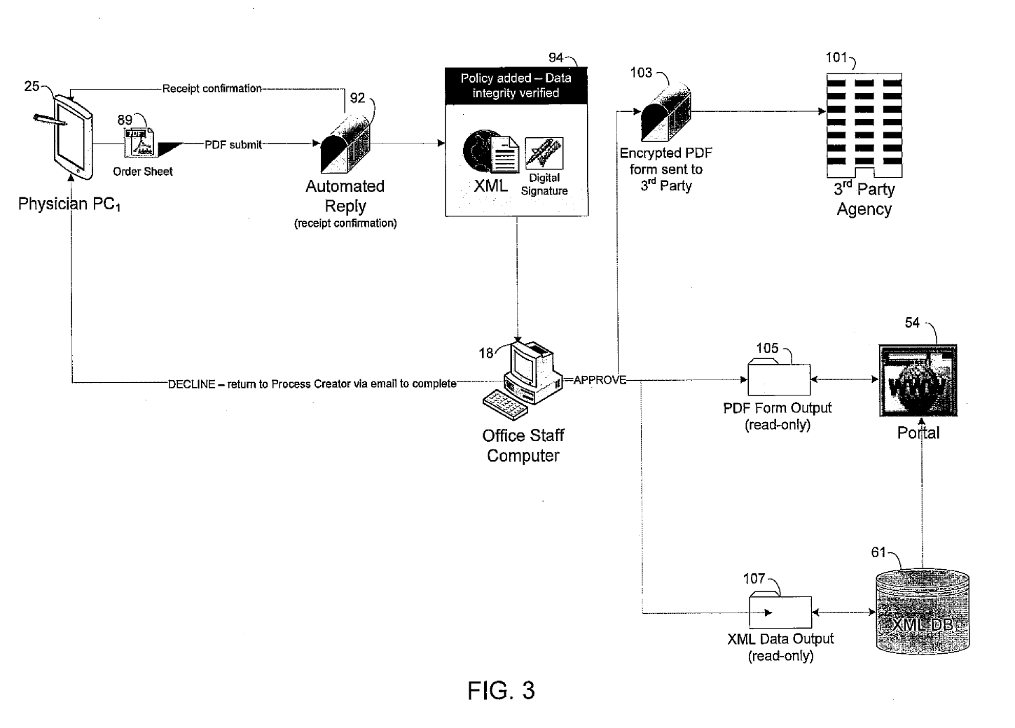

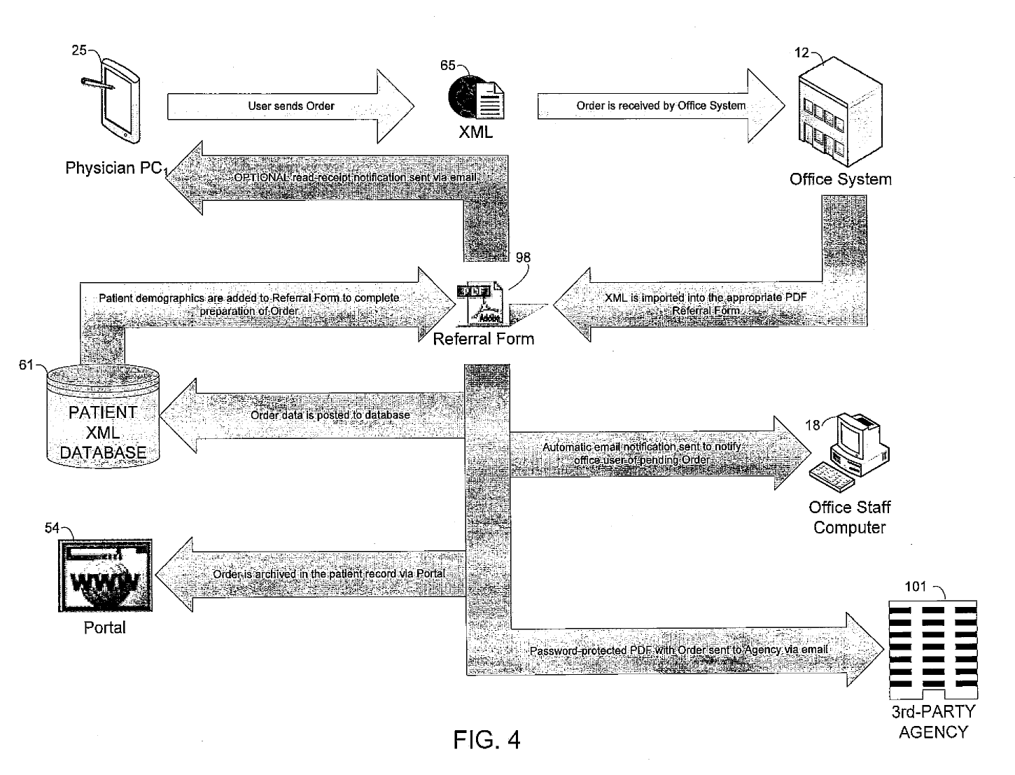

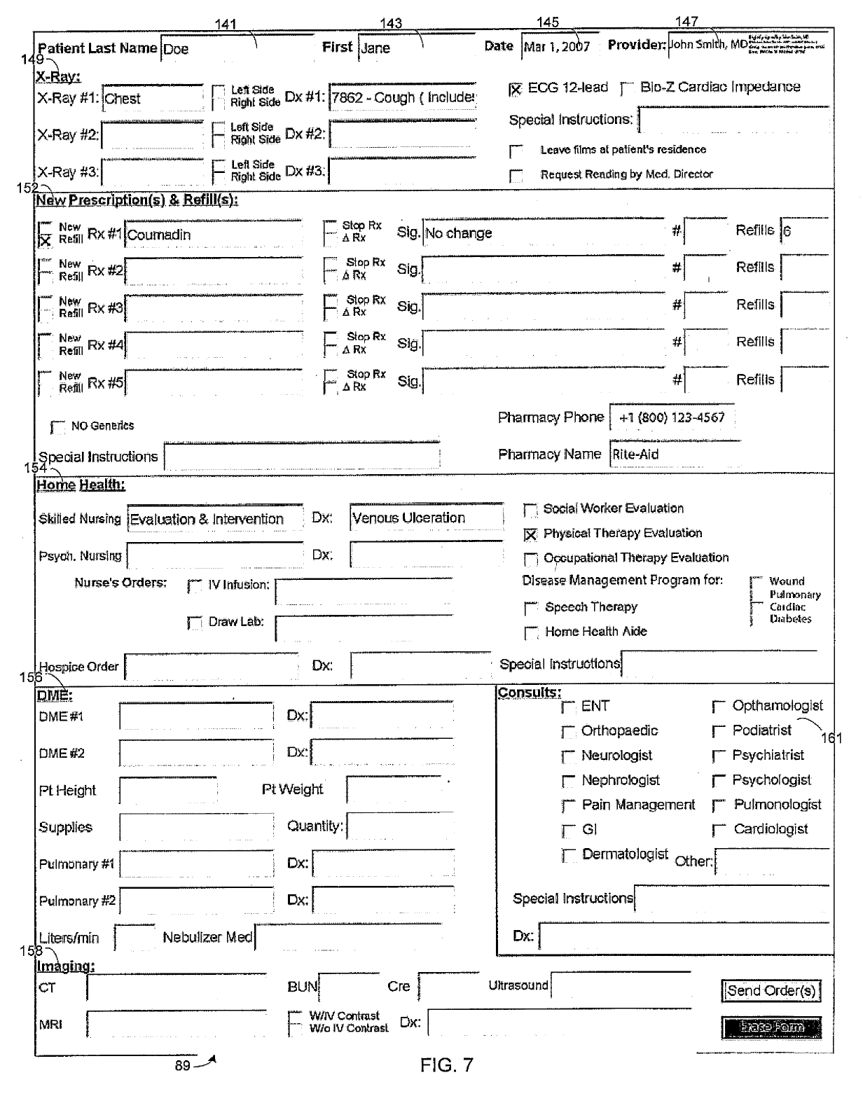

Referring now to FIGS. 3 and 4, there is shown a pair of flow diagrams of sequences for a physician sending an order for goods or services to and/or from a third party agency. The sequence may be initiated by the physician completing on his/her portable computer 25 an order form 89, as shown in FIG. 7, or including an order in the patient form 65 (FIG. 2), both forms may include a digital signature by the physician. The physician may then submit the order via the order form 89 or the patient form 65 during or resulting from a visit at the patient's home to the office system 12 using his/her portable computer 25. Upon receipt of the order form 89 or patient form 65, the office system 12 may provide an automated reply as indicated at 92 (FIG. 3) to the portable computer 25 of the physician to acknowledge the receipt of the form.

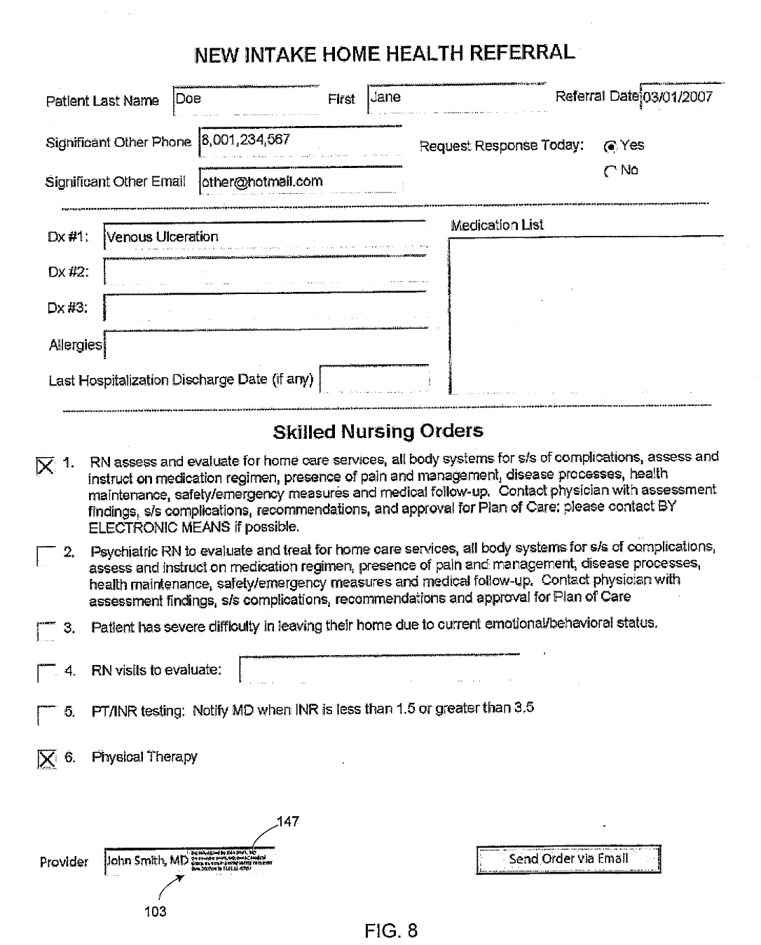

Upon receipt of the data from the order form 89 or patient form 65 from the physician via the portable computer 25, the office system 12 may check the validity of the digital signature using a certificate authority and verify the integrity of the data to insure the data was not modified after the application of the digital signature. Once the integrity of the data is verified, the office system 12 may analyze the data to determine what good or service is being requested by the order. Once the appropriate good or service is identified, the office system 12 may prepare an appropriate referral form 98, an example is shown in FIG. 8, for placing the order with a third party agency 101 using information regarding the specific patient acquired from the database 61. The referral form 98, as shown in FIG. 8, may be specifically tailored to the requirements of the desired third party agency 101, including required specific patient information and the third-party agency's logo.

The referral form 98 may then be emailed to the office staff computer 18 for review by a member of the office staff. If the referral form is declined, the form may be sent to the physician's portable computer 25 to enable the physician to resolve any discrepancies. If the referral form is approved, an encrypted referral form 103 may be emailed to the third party agency 101, a referral form 105 in read-only format may be posted on the office system portal 54 for viewing, and the referral form data 107 in read-only format may be provided to the database 61 for updating the patient's medical record.

The office system and the physician portable computers may both utilize a plurality of software packages for communication, document management, document creation and manipulation. One such software package may be Adobe® LiveCycle™ Workflow, which provides a plurality of document processes including the use of PDF and XML documents.

Referring now to FIG. 6, there is shown an example of a completed patient form 65 that may be sent by the physician to the office system using his/her portable computer. At a top portion of the form, generally referenced as 121, information regarding the patient and the visit may be pre-filled into the form by the office system prior to providing the form in an email to the physician. Below that information and slightly more that one half the way down the form may be an area for the physician to manually enter information on the form. The information on the left side, generally referenced as 123, may be notes entered by the physician regarding the visit including but not limited to an assessment, information received from the patient, and a treatment plan. The information on the right side, generally referenced as 125, may be area to enter the vital signs of the patient and check-offs for other patient information.

Below the physician entered information may be an area 127 to indicate when a follow-up visit should be scheduled and an area 129 for entering point of care laboratory testing results labeled LABS for recording readings wirelessly transmitted to, or manually entered into, the physician's portable computer such, for example, as from sensors physically attached to the patient. There is also an area 132 to indicate the procedures performed and an area 134 to record billing information, as well as an area 136 to list the diagnoses. A digital signature 138 may be included near the bottom of the form.

Referring now to FIG. 7, there is shown an order form 89 that may be completed by the physician to order various goods and services for the treatment of the patient. The top of the order form may include areas for the patient's name 141 &143, the date 145, and a digital signature 147. The remainder of the order form may include areas to order X-rays 149, prescriptions 152, home health service 154, durable medical equipment 156, imaging 158, and/or consultations 161 for the patient. The physician may be able to select the third party agency to provide the ordered goods or services, if more than one third party agency has been pre-approved to provide the ordered good or service.

Referring now to° FIG. 8, there is shown an example of a referral form 103 to place the order with the appropriate third party agency. The referral form may be custom made by the office system to be a look-alike, including the logo, for the third party agency's own form to insure inclusion of all patient data required by the third party agency. The referral form may be populated from information taken from the order form and from information obtained from the database of the office system. The referral forms for different third party agencies may vary greatly depending on the good or service being provided and the information required to provide that good or service.

The patient management system 10 may allow real-time scheduling of house call visits; paperless patient information and document management; remote access to unified email, voicemail, and other communications; customer user interfaces for inputting data from portable medical and diagnostic devices; electronic retrieval of laboratory outcomes and analysis; electronic ordering of prescriptions, devices, and consultations; centralized administration and storage of patient information; billing and HIPAA compliance; and reporting for tracking auditable events, patient health and disease management, and physician house call activity.

The patient management system 10 may provide centralized call center and telephone triage to prioritize incoming calls, then quickly locate, assign, and direct physicians to the house calls based on their geographic proximity using a GPS navigation system. The physicians may receive instant notification of scheduled house calls, including time and location of house call, patient demographics, medical symptoms, and map routing. Follow-up visits may be automatically scheduled and instantly synchronized with the patient management system schedule. The patient maintenance system may allow the tracking of the amount of time it takes a physician to respond to and complete his/her house calls.

The physician making house calls may be equipped with a portable tablet or laptop personal computer with a digital ink feature allowing them to take notes and update information in their preferred manner. The physicians may use the mobile personal computer to retrieve, review, import, and update patient information directly. The physician may print out and share easy-to-read patient reports with the patient and the patient's family using a portable computer. All changes to the patient information may be automatically captured and stored in a centralized location, ensuring consistency and accuracy. The physicians may use their mobile personal computer to write and fill prescriptions, order labs, medical equipment, home health and hospice services, and consultations, as well as admit patients to hospitals.

The patient management system 10 may support capturing data from a range of portable medical devices that allow physicians making house calls to deliver many of the same or similar clinical services available in hospital labs and emergency rooms. These mobile devices, many small enough to fit in the palm of a hand, enable the physician to treat more critical patients, more cost effectively, in the home. These portable medical devices may include portable x-ray machines, BIO “Z” ICG technology, pulse oximeters, lab analyzers, portable ultrasound machines, handheld MRI scanners, automatic defibrillators, and EKG cardiac output monitoring.

By integrating with these medical devices, the patient management system 10 may enable the physician to collect samples, run lab work and diagnostic tests, electronically retrieve and capture outcomes and analysis (often within minutes), present lab results in an easy-to-read, printable format, and electronically update a patient's medical records. All of these things may be accomplished by the physician without ever leaving the patient's home or even the patient's bedside.

The patient management system 10 may move the physicians making house calls into the mobile world of wireless, broadband communications allowing them to keep connected with their patients, colleagues, and information. The patient maintenance system may allow these physicians to access all their messages—email, voicemail, pages, faxes, etc.—through one unified, user-friendly interface. The unification of messaging may also provide a clear, easy-to-track audit trail of messages. In addition, the physicians may electronically share emails, voice messages, lab results, and complete medical records with colleagues, hospitals, pharmacies, and labs, while maintaining HIPAA-mandated levels of privacy and security.

While particular embodiments of the present invention have been disclosed, it is to be understood that various different embodiments are possible and are contemplated within the true spirit and scope of the appended claims. There is no intention, therefore, of limitations to the exact abstract or disclosure herein presented.

What is claimed is:

1. A patient management system for clinicians making house calls, comprising:
a portable computer for each clinician making house calls;
centralized electronic storage for patient medical records; and
an office system for communicating with the portable computers and the centralized storage, and for providing online access to the centralized storage.

2. The system according to claim 1, wherein the office system includes a portal for permitting communication via the Internet.

3. The system according to claim 2, further including an office staff computer for communicating with the office system via the portal.

4. The system according to claim 2, wherein the patient medical records are viewable via the portal.

5. The system according to claim 2, wherein appointment data is provided to the office system via the portal.

6. The system according to claim 1, wherein the centralized storage includes a medical records database.

7. The system according to claim 1, wherein each portable computer includes tillable forms for use by the clinicians when making house calls.

8. The system according to claim 7, wherein the office system provides patient data regarding a patient to be visited to one of the portable computers for pre- filling at least one of the fillable forms.

9. The system according to claim 8, wherein the patient data is in XML format.

10. The system according to claim 8, wherein the office system obtains at least part of the patent data from the centralized storage.

11. A method of patient management for clinicians making house calls, comprising:
providing portable computers for the clinicians to use when making house calls;
receiving appointment data regarding an appointment for a patient with a selected clinician at a predetermined time;
transmitting appointment information regarding the appointment to the selected clinician via his provided portable computer;
transmitting patient data to the selected clinician's portable computer;
pre-filling a form with the patient data at the selected clinician's portable computer;
receiving from the selected clinician's portable computer patient visit data electronically added to the form during the appointment;
acknowledging the receipt of the patient visit data;
verifying the patient visit data; and
updating the patient's medical records.

12. The method according to claim 11, wherein the appointment information includes an address for the patient.

13. The method according to claim 11, further including receiving the patient data from a centralized database.

14. The method according to claim 11, wherein the patient data is transmitted in XML format.

15. The method according to claim 11, wherein the form is in PDF format.

16. The method according to claim 11, wherein the patient visit data is transmitted in XML format.

17. The method according to claim 11, wherein the acknowledging the receipt of the patient visit data includes sending an email to the selected clinician.

18. The method according to claim 11, wherein the patient visit data includes a digital signature of the selected clinician.

19. The method according to claim 18, wherein the verifying of the patient visit data includes verifying the digital signature of the selected clinician.

20. The method according to claim 13, wherein the updating the patient's medical records includes storing the verified patient visit data in the centralized database.

21. The method according to claim 11, further including determining if the selected clinician dictated notes to a transcription service.

22. The method according to claim 21, further including receiving a transcription of the dictated notes.

23. The method according to claim 22, further including adding the transcription to the patient visit data.

24. The method according to claim 11, further including generating a completed form using the patient data and the patient visit data.

25. The method according to claim 24, further including conducting a quality assurance review of the completed form.

26. The method according to claim 25, further including sending an email to the selected clinician if the completed form is declined during the quality assurance review.

27. The method according to claim 11, further including:
receiving order data from the selected clinician's portable computer;
generating an order form using the order data; and
transmitting the order form to a third party provider.

28. The method according to claim 27, further including:
acknowledging the receipt of the order data; and
verifying the order data.

29. The method according to claim 27, further including receiving an approval of the order form.

30. The method according to claim 27, further including storing the order data in the centralized database.

31. The method according to claim 27, wherein the generating the order form includes receiving additional information from a centralized database.

32. The method according to claim 27, wherein the order data is included with the patient visit data.

33. A patient management system for a plurality of medical groups having clinicians making house calls, comprising:
at least one portable computer for each of the medical groups;
centralized electronic storage for storing patient medical records of the medical groups; and
an office system for communicating with the medical groups and the centralized storage, and providing access to the centralized storage.

34. The system according to claim 33, wherein the office system includes a portal for allowing communication via the Internet.

35. The system according to claim 34, further comprising an office staff computer in at one of the medical groups for communicating with the office system via the portal.

36. The system according to claim 34, wherein the patient medical records are viewable via the portal.

37. The system according to claim 34, wherein appointment data is provided to the office system via the portal.

38. The system according to claim 33, wherein the centralized storage includes a medical records database.

39. The system according to claim 33, wherein each portable computer includes fillable forms for use by the clinicians when making house calls.

40. The system according to claim 39, wherein the office system provides patient data regarding a patient to be visited to one of the portable computers for pre-filling at least one of the tillable forms.

41. The system according to claim 40, wherein the patient data is in XML format.

42. The system according to claim 40, wherein the office system obtains at least part of the patient data from the centralized storage.

43. The system according to claim 33, wherein the office system includes a schedule module for scheduling the house calls for each of the medical groups.

44. The system according to claim 33, wherein the office system includes a forms module for providing fillable forms to the medical care groups.

45. The system according to claim 33, wherein the office system includes a data management module for storing, retrieving, and updating the patient medical records.

46. The system according to claim 33, wherein the office system includes a communication module for communicating with the medical groups and providing access to the centralized storage.

47. The system according to claim 33, wherein the office system includes a data verification module for checking and verifying data from the medical groups and for verifying the authenticity of the data.
